(19) United States
(12) Patent Application Publication
(10) Pub. No.: US 2021/0114113 A1
(43) Pub. Date: Apr. 22, 2021

(54) AIRFLOW ADJUSTMENT

(71) Applicant: HEWLETT-PACKARD DEVELOPMENT COMPANY, L.P., Spring, TX (US)

(72) Inventors: Joshua Peter Yasbek, Vancouver, WA (US); Todd Goyen, Vancouver, WA (US); Pierre J. Kaiser, Vancouver, WA (US)

(21) Appl. No.: 17/040,610

(22) PCT Filed: Jul. 27, 2018
(86) PCT No.: PCT/US2018/044016

§ 371 Date: Sep. 23, 2020

(51) Int. Cl. B22F 12/70; B33Y 30/00; B33Y 50/02; B29C 64/393; B29C 64/364; B33Y 40/00; B28B 1/00; B28B 17/00; B22F 12/90; B22F 10/28; B01D 46/00; B01D 46/44

(52) U.S. Cl. CPC B22F 12/70; B33Y 30/00; B33Y 50/02; B29C 64/393; B29C 64/364; B33Y 40/00; B01D 2273/30; B28B 17/0081; B22F 12/90; B22F 10/28; B01D 46/0086; B01D 46/444; B01D 46/0043; B28B 1/001

(57) ABSTRACT

In some examples, a controller is to receive a measurement from a sensor in an enclosure, and use the measurement and a baseline value to represent a condition of an airflow flowing through a filter that removes particulates from an incoming airflow into the enclosure. Based on the measurement and the baseline value, the controller is to selectively adjust a setting of an airflow generator that causes the incoming airflow through an inlet into the enclosure, or indicate that the filter is to be replaced.

### BACKGROUND

Thermal imaging devices, such as non-contact thermal cameras, may be used to provide thermal feedback in systems that generate heat, such as additive manufacturing machines (e.g., three-dimensional or 3D printing systems). For example, by monitoring the heat generated within a system, temperature conditions that may damage the system, or parts of the system, or that may affect a process being performed by the system, can be detected.

### BRIEF DESCRIPTION OF THE DRAWINGS

Some implementations of the present disclosure are described with respect to the following figures.

FIG. 1 is a block diagram of an additive manufacturing machine according to some examples.

FIG. 2 is a flow diagram of a process of compensating for a filter condition, according to some examples.

FIG. 3 is a block diagram of an apparatus according to some examples.

FIG. 4 is a block diagram of a storage medium storing machine-readable instructions according to some examples.

FIG. 5 is a block diagram of an additive manufacturing machine according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

An additive manufacturing machine such as a three-dimensional (3D) printing system can build 3D objects by forming successive layers of build material and processing each layer of build material on a build platform. In some examples, a build material can include a powdered build material that is composed of particles in the form of fine powder or granules. The powdered build material can include metal particles, plastic particles, polymer particles, ceramic particles, or particles of other powder-like materials. In some examples, a build material powder may be formed from, or may include, short fibers that may, for example, have been cut into short lengths from long strands or threads of material.

As part of the processing of each layer of build material, agents can be dispensed (such as through a printhead or other liquid delivery mechanism) to the layer of build material. Examples of agents include a fusing agent (which is a form of an energy absorbing agent) that absorbs the heat energy emitted from an energy source used in the additive manufacturing process. For example, after a layer of build material is deposited onto a build platform (or onto a previously formed layer of build material) in the additive manufacturing machine, a fusing agent with a target pattern can be deposited on the layer of build material. The target pattern can be based on an object model (or more generally, a digital representation) of the physical 3D object that is to be built by the additive manufacturing machine.

According to an example, a fusing agent may be an ink-type formulation including carbon black, such as, for example, the fusing agent formulation commercially referred to as the V1Q60Q “HP fusing agent” available from HP Inc. In an example, a fusing agent may additionally include an infrared light absorber, a near infrared light absorber, a visible light absorber, or an ultraviolet (UV) light absorber. Fusing agents can also refer to a chemical binding agent, such as used in a metal 3D printing system. In further examples, other types of additive manufacturing agents can be added to a layer of build material.

Following the application of the fusing agent, an energy source (e.g., including a heating lamp or multiple heating lamps that emit(s) energy) is activated to sinter, melt, fuse, bind, or otherwise coalesce the powder of the layer of build material underneath the fusing agent. The patterned build material layer (i.e., portions of the layer on which the fusing agent was deposited) can solidify and form a part, or a cross-section, of the physical 3D object.

Next, a new layer of powder is deposited on top of the previously formed layer, and the process is re-iterated in the next additive manufacturing cycle to form 3D parts in the successive layers of build material. The 3D parts collectively form a 3D object (or multiple 3D objects) that is the target of the build operation.

Thermal imaging devices, such as non-contact thermal cameras, can be used to measure the temperature of layers of build material during a build operation. For example, thermal imaging devices can be used to check for proper fusion or solidification of a build material when building a part. A thermal imaging device can be used to measure a build material layer to ensure that the build material layer is at a target temperature (or within a target temperature range). In other examples, thermal imaging devices can be used to monitor temperatures associated with other processes in additive manufacturing machines.

Although the present discussion refers to thermal imaging devices used in additive manufacturing machines, it is noted that techniques or mechanisms of the present disclosure can also be applied in other types of systems in other examples, such as in other types of manufacturing systems, medical machines, and so forth.

In some environments (such as environments of additive manufacturing machines), particulates (e.g., powder) or other contaminants can become airborne and may adhere to a lens or other component of a thermal imaging device. Accumulation of contaminants on thermal imaging device can interfere with operation of the thermal imaging device, such that the thermal imaging device may no longer be able to accurately measure a temperature.

For example, with sufficient accumulation of contaminants, the thermal imaging device may detect the temperature of the accumulated contaminants rather than a target object.

Contaminant accumulation can also be an issue with other types of imaging devices. Other types of imaging devices include optical cameras, optical sources (e.g., laser sources), and any other device that captures light or images (in the visible spectrum or outside the visible spectrum, such as infrared or ultraviolet light) and/or emits light.

More generally, an “imaging device” can refer to a device that is able to capture light or an image in either or both of the visible and invisible spectra, and/or can refer to a device that emits light in either or both of the visible and invisible spectra.

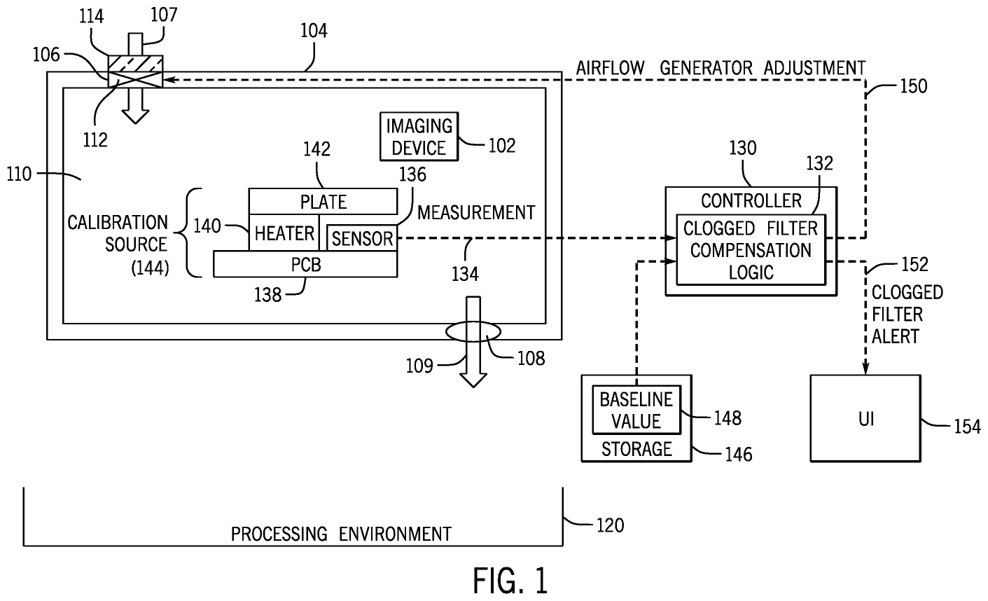

FIG. 1 shows an example arrangement of an additive manufacturing machine. Although reference is made to additive manufacturing machines in some examples, it is noted that techniques or mechanisms according to some implementations can be applied in other systems in which imaging devices are used and where contaminant accumulation on the imaging devices is a concern.

As shown in FIG. 1, to reduce or eliminate accumulation of contaminants on an imaging device 102, the imaging device 102 can be placed in an enclosure 104 that has an airflow inlet 106 and an outlet aperture 106. The enclosure 104 can be formed with a housing that defines an inner chamber 110 in which the imaging device 102 is located. The housing of the enclosure 104 can be formed of any of various materials, including any or some combination of a metal, a plastic, a polymer, glass, and so forth. The housing of the enclosure 104 can be formed of a transparent, translucent, or opaque material. Additionally, although the enclosure 104 is shown as having a rectangular profile, it is noted that the enclosure 104 can have profiles with other shapes in other examples.

Air can be drawn into the enclosure 104 through the airflow inlet 106 (generally along arrow 107). The air drawn into the enclosure 104 can include clean or purified air that is substantially free of contaminants. The aperture 108 allows air to escape from the enclosure 104 (generally along arrow 109). The inlet 106 and the aperture 108 can be sized to maintain an air pressure level in the enclosure 104 that is greater than the air pressure of a processing environment 120 outside the enclosure 104. In this manner, any contaminants that may be present in the processing environment 120 outside the enclosure 104 are prevented from entering the enclosure 104, thereby protecting the imaging device 102 from contaminant accumulation. As a result, the imaging device 102 can perform imaging (light or image capture and/or light emission) with respect to the processing environment 120 outside the enclosure 104 while avoiding substantial contaminant accumulation (e.g., accumulation of build material powder) on the imaging device 102.

Although reference is made to producing a flow of air through the enclosure 104, it is noted that in other examples, other types of gases can be caused to flow through the enclosure 104. Thus, the term “airflow” as used herein can refer to a flow of air or any other type of gas.

The processing environment 120 can include, for example, a build chamber of an additive manufacturing machine, where layers of powdering build material are provided and processed by applying agents and heating. In such examples, the imaging device 102 can be used to sense a temperature of a layer of build material that is currently being processed in the processing environment 120.

Although just one inlet 106 and/or one aperture 108 are depicted in FIG. 1, it is noted that in other examples, the enclosure 104 can have multiple inlets 106 and/or multiple apertures 108.

As further shown in FIG. 1, an airflow generator 112 (e.g., a fan) is attached to the enclosure 104 to draw air through the inlet 106. In some examples, a filter 114 can be positioned upstream (from the perspective of the airflow represented by the arrow 107) of the airflow generator 112. The filter 114 is designed to remove or reduce the amount of contaminants entering the inner chamber 110 of the enclosure 104 through the inlet 106.

Although FIG. 1 shows the airflow generator 112 as being attached to the enclosure 104 and positioned in the inlet 106, it is noted that in other examples, other arrangements of the airflow generator 112 can be provided. For example, the airflow generator 112 can be located inside the enclosure 104, or alternatively, the airflow generator 112 can be located upstream of the enclosure 104 to direct airflow to the inlet 106. In both the foregoing cases, the filter 114 can be positioned in the inlet 106 to filter contaminants in the airflow passing through the inlet 106.

In addition to reducing contaminants, the filter 114 can also aid in reducing the air outflow through the aperture 108. If the rate of airflow exiting the aperture 108 is high, then the exiting airflow may disturb the processing that is being performed in the processing environment 120 (such as by blowing build material powders around in the processing environment 120). The filter 114 can maintain the rate of exiting airflow (within a target range) such that the exiting airflow from the aperture 108 has a minimal or reduced effect on the processing performed in the processing environment 120.

Although reference is made to one airflow generator 112 and/or one filter 114, it is noted that there can be multiple airflow generators and/or multiple filters in other examples.

Over time and use, the filter 114 can become clogged with particulates. The clogged filter 114 causes an increased flow impedance. In such a scenario, the rate of exiting airflow (109) through the aperture 108 may be too low, in which case the enclosure 104 may no longer be purged properly if particulates in the processing environment 120 are able to enter through the aperture 108 into the inner chamber 110 of the enclosure 104.

Additionally, the reduced airflow caused by the clogged filter 114 can lead to the imaging device 102 being unable to maintain an isothermal condition. An isothermal condition of the imaging device 102 refers to a condition in which the imaging device 102 is maintained at a target temperature (or within a target range of temperatures). Maintaining the imaging device 102 at the target temperature or target range of temperatures aids in accuracy of the imaging device 102. In some examples, feedback control can be used to maintain the imaging device 102 in its isothermal condition. If the imaging device 102 deviates from the target temperature or target range of temperatures, then the imaging device 102 may no longer accurately make measurements (such as thermal measurements or capture images), or the imaging device 102 may not emit light in a target manner.

Whether or not the imaging device 102 is maintained in the isothermal condition can also be affected by an ambient temperature that affects the temperature of the incoming airflow drawn into the enclosure 104 through the inlet 106. For example, if the incoming airflow's temperature is too high, then that can cause the temperature of the imaging device 102 to rise given the same airflow rate.

Accordingly, there are several goals that are to be achieved by a control system for a processing environment: (1) maintain an airflow through an enclosure containing an imaging device that is sufficient to prevent or reduce contaminant ingress into the enclosure, (2) maintain a thermal condition of the imaging device within a target range, and (3) maintain air outflow from an aperture of the enclosure within a target range to avoid or reduce disturbance of a processing environment.

In accordance with some implementations of the present disclosure, to achieve reduced (or minimal) contaminant ingress into the enclosure 104, reduced (or minimal) disturbance of the processing environment 120, and maintenance of the imaging device 102 in its isothermal condition, anemometer-based techniques or mechanisms provide feedback on an estimated condition of the filter 114 and an estimated outflow parameter of the airflow exiting the aperture 108. Using the anemometer-based techniques or mechanisms, a controller 130 is able to selectively adjust the airflow generator 112 to compensate for a change in condition of the filter 114 (e.g., as the filter 114 becomes progressively more clogged with use), and provide an alert of when replacement of the filter 114 is to be performed if further adjustment of the airflow generator 112 cannot be performed to compensate for the changed condition of the filter 114.

As used here, a “controller” can refer to a hardware processing circuit, which includes any or some combination of the following: a microprocessor, a core of a multi-core microprocessor, a microcontroller, a programmable integrated circuit device, a programmable gate array, or any other type of hardware processing circuit. Alternatively, a “controller” can refer to a combination of a hardware processing circuit and machine-readable instructions (software and/or firmware) executable on the hardware processing circuit.

The controller 130 includes a clogged filter compensation logic 132 to perform compensation for a condition of the filter 114 as discussed above. The clogged filter compensation logic 132 can be implemented as a portion of the hardware processing circuit of the controller 130, or as machine-readable instructions executable on the controller 130.

The clogged filter compensation logic 132 receives a measurement 134 from a sensor 136 that is provided inside the enclosure 104. In the example shown in FIG. 1, the sensor 136 is mounted on a printed circuit board (PCB) 138. A heater 140 is also mounted on the PCB 138. The heater 140 is used to heat a calibration plate 142 that is used for calibrating the imaging device 102. The heater 140 can be implemented with any of various types of heat sources, including, for example, a transistor that heats up with electrical current flowing through the transistor, or any other type of electrically-controlled heat source.

The calibration plate 142 can be formed of a material that has a relatively high thermal conductivity, such as aluminum, another metal, and so forth. The heater 140 is used to heat the calibration plate 142 to a target temperature. Heating the calibration plate 142 to the target temperature can refer heating the calibration plate 142 to exactly the target temperature or to a temperature that is within a range of temperatures including the target temperature. Although not shown, the PCB 138 can also include a temperature sensor to detect the temperature of the calibration plate 142, such that the heater 140 can be adjusted to maintain the calibration plate 142 at the target temperature. Adjustment of the heater 140 is based on circuitry of the PCB 138 adjusting an amount of electrical current (or power) provided to the heater 140.

The sensor 136 is used to produce the measurement 134 that corresponds to the amount of electrical current provided to the heater 140 to maintain the plate 142 at the target temperature. The measurement 134 can be an electrical current measurement (that represents an amount of electrical current flowing to the heater 140) or a power measurement (that represents the amount of power consumed by the heater 140) or any other indication of how much energy or power is consumed by the heater 140 to maintain the calibration plate 142 at the target temperature.

To perform calibration, the calibration plate 142 is moveable to a position within a field of view of the imaging device 102. The imaging device 102 can then be used to measure a thermal condition (e.g., a temperature) of the calibration plate 142, to verify whether the imaging device 102 is operating in an expected manner. For example, if a temperature captured by the imaging device 102 is equal to the target temperature of the calibration plate 142, or within some tolerance of the target temperature, then the imaging device 102 is considered to be operating correctly. However, if the temperature captured by the imaging device 102 is outside of a range that includes the target temperature, then the imaging device 102 is considered to not be operating correctly. In the latter case, measurement produced by the imaging device 102 can be calibrated to compensate for the inaccurate thermal measurement made by the imaging device 102.

The combination of the PCB 138, the heater 140, and the calibration plate 142 is considered to be part of a calibration source 144 that is used for calibrating the imaging device 102.

In other examples, the calibration source 144 can have a different arrangement of components.

The additive manufacturing machine of FIG. 1 also includes a storage 146, which can include a memory device (or multiple memory devices) or another type of storage device (or storage devices). The storage 146 stores a baseline value 148, which is empirically determined (such as based on experimentation) for a clean filter. In the example of FIG. 1, the baseline value 148 can be a baseline electrical current value or a baseline power value that corresponds to the amount of electrical current or power to be applied to the heater 140 to maintain the calibration plate 142 at the target temperature when a clean filter (i.e., a filter that is not clogged with contaminates) is used in the inlet 106 of the enclosure 104.

In other examples, the storage 146 can store multiple baseline values 148 for different ambient temperature conditions (discussed further below).

The clogged filter compensation logic 132 can use the measurement 134 from the sensor 136 and the baseline value 148 to estimate a condition of an airflow through the filter 112. More specifically, the clogged filter compensation logic 132 can compare the measurement 134 to the baseline value 148 to estimate whether the filter 112 is clogged by more than a threshold. For example, if a difference between the measurement 134 and the baseline value 148 exceeds a specified amount, then that indicates that the filter 114 has been clogged beyond the threshold.

In response to the estimated condition of the airflow through the filter 114, the clogged filter compensation logic 132 can selectively, for respective conditions, (1) produce an airflow generator adjustment indication 150 that is provided to the airflow generator 112 to adjust the airflow generator 112, or (2) produce a clogged filter alert 152 that can be displayed in a user interface (UI) 154 to alert a user of the clogged filter condition. The clogged filter alert 152 can be an indication that the filter 114 is to be replaced. The UI 154 can be displayed in a display device of the additive manufacturing machine, or alternatively, on a remote electronic device that is coupled to the additive manufacturing machine over a network.

In other examples, instead of displaying the clogged filter alert in the UI 154, the clogged filter alert 152 can be communicated to a control system to cause an automated response to the clogged filter condition, such as a temporary shutdown of the additive manufacturing machine, a slowdown in the operation of the additive manufacturing machine, and so forth.

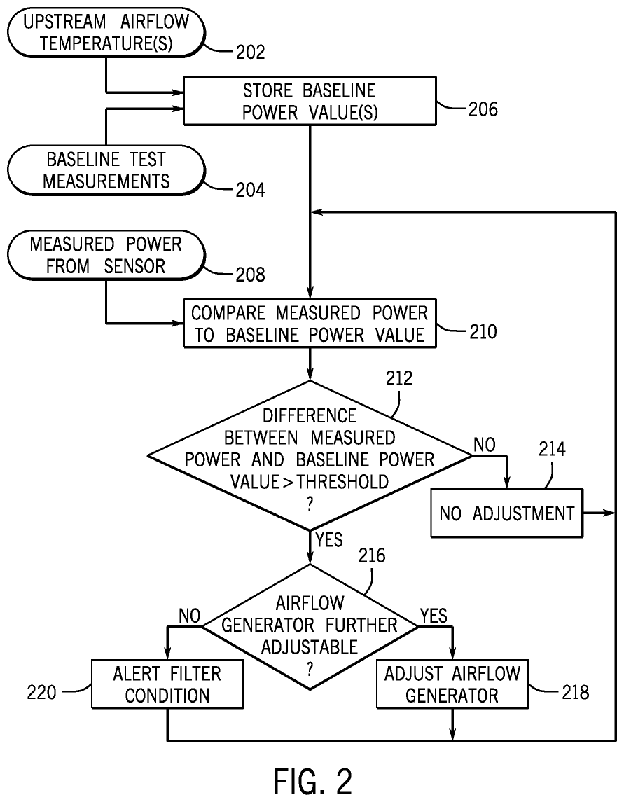

FIG. 2 is a flow diagram of a process that is performed by the clogged filter compensation logic 132 according to some examples. The clogged filter compensation logic 132 receives an upstream airflow temperature (or multiple upstream airflow temperatures) 202 that correspond to baseline test measurements 204 made with respect to a clean filter. The baseline test measurements 204 are performed to determine the amount of power used to maintain the calibration plate 142 at a target temperature, while minimizing (or reducing) the air outflow rate from the aperture 108 of the enclosure 104 to minimize (or reduce) disturbance of the processing environment 120, and to maintain the imaging device 102 in an isothermal condition.

An upstream airflow temperature 202 refers to the ambient temperature of incoming air that enters the enclosure 104 through the inlet 106. Different upstream airflow temperatures 202 (corresponding to different ambient temperature conditions) can cause different amounts of power used by the heater 140 to maintain the calibration plate 142 at the target temperature.

The clogged filter compensation logic 132 stores (at 206) a baseline power value that represents the power used to maintain the calibration plate 142 at the target temperature, for a given upstream airflow temperature. If multiple upstream airflow temperatures 202 are considered, than multiple respective baseline power values can be stored (at 206) (such as in the storage 146 of FIG. 1), with each baseline power value corresponding to a respective different upstream airflow temperature 202.

The clogged filter compensation logic 132 also receives a measured power 208 from the sensor 136 during an actual operation of the additive manufacturing machine. The measured power 208 represents the amount of power used by the heater 140 to maintain the calibration plate 142 at the target temperature.

If the filter 114 is less clogged, then impedance to airflow presented by the filter 114 is reduced, which means that the rate of airflow entering the enclosure 104 is higher. On the other hand, if the filter 114 is clogged, then the impedance to airflow presented by the filter 114 is increased, which means that the rate of airflow entering the enclosure 104 is decreased. When the rate of airflow entering the enclosure 104 is decreased, that means that less cooling of the calibration plate 142 occurs, which means that less power will be consumed by the heater 140 to heat the calibration plate 142 to the target temperature. On the other hand, if the filter 114 is not clogged or is lightly clogged, the increased rate of airflow entering the enclosure 104 results in greater cooling of the calibration plate 142, which means that more power will be consumed by the heater 140 to heat the calibration plate 142 to the target temperature.

Effectively, the power consumed by the heater 140 to heat the calibration plate 142 to the target temperature provides an implicit indication of the airflow condition (and correspondingly, the condition of the filter 114). In this way, the calibration source 144 of FIG. 1 (which includes the calibration plate 142 and the heater 140) can be used as an anemometer to provide an indication of an airflow condition of the enclosure 104 (and correspondingly, the condition of the filter 114). The power consumed by the heater 140 to heat the calibration plate 142 to the target temperature also correlates to a flow parameter of an air outflow from the outlet aperture 108 of the enclosure 104.

The amount of power to maintain the calibration plate 142 at the target temperature depends upon two factors: (1) the rate of airflow through the inlet 106, and the upstream airflow temperature. The upstream airflow temperature can be measured, and can be used to select the appropriate baseline power value. However, the rate of airflow through the inlet 106 is not directly measured, and can be affected by a condition of the filter 114. An implicit measurement of an airflow condition through the inlet 106 (and thus the condition of the filter 114) is based on the measurement 134 provided by the sensor 136.

Although reference is made to using a baseline power value and a measured power, it is noted in other examples, a different baseline value and a different measurement can be used, such as in a baseline electrical current value and a measured electrical current, or any other values that represent an amount of energy or power to be used by the heater 140 to maintain the calibration plate 142 at the target temperature.

The clogged filter compensation logic 132 compares (at 210) the measured power 208 to the baseline power value. If there are multiple baseline power values stored, then the baseline power value that is selected for the comparison (at 210) is the baseline power value corresponding to a detected upstream airflow temperature during operation of the additive manufacturing machine.

The clogged filter compensation logic 132 determines (at 212) if the difference between the measured power and the baseline power value is greater than a specified threshold. The specified threshold can be statically configured, or can be dynamically configured based on operation of the additive manufacturing machine.

If the difference is not greater than the specified threshold, then the clogged filter compensation logic 132 does not make any adjustment (at 214), and the process can return to task 210 for the next iteration (e.g., in the next periodic cycle or in response to a specified event).

If the difference between the measured power and the baseline power value is greater than the threshold, then that is an indication that the filter 114 is excessively clogged. In such a condition, the clogged filter compensation logic 132 determines (at 216) whether the airflow generator is further adjustable to compensate for the clogged filter. For example, the airflow generator 112 can have a setting that determines a speed of rotation of a fan that produces airflow or a rate of airflow produced by the airflow generator 112. The setting can be, for example, a pulse width modulation (PWM) setting, which governs a duty cycle of a signal provided to activate the airflow generator 112. A maximum setting can be set for the airflow generator 112, where the airflow generator 112 is not to exceed the maximum setting to compensate for a clogged filter.

In response to determining that the airflow generator is further adjustable, the clogged filter compensation logic 130 adjusts (at 218) the airflow generator 112. The adjustment of the airflow generator can include adjusting the setting, such as the PWM setting, of the airflow generator 112. More specifically, the adjusting of the airflow generator 112 causes the airflow generator to increase its operational setting to produce more airflow.

If the clogged filter compensation logic 132 determines (at 216) that the airflow generator is not further adjustable, then the clogged filter compensation logic 132 produces an alert (at 220) of the filter condition, which can be an indication to replace a clogged filter.

As the filter 114 becomes contaminated over time, the outflow associated with a constant airflow generator input will decrease. This has implications for maintaining the isothermal condition of the imaging device 102 as well as the imaging device 102 accuracy if the outflow through the aperture 108 can no longer resist the ingress of contaminants onto the optical surfaces of the imaging device 102. By using the calibration source as an anemometer, intelligent control the convective properties of the outflow can be achieved by varying the setting of the airflow generator 112 over the life of the filter 114, with replacement of the filter 114 performed when the setting of the airflow generator 114 can no longer be varied to compensate for the clogged filter 114.

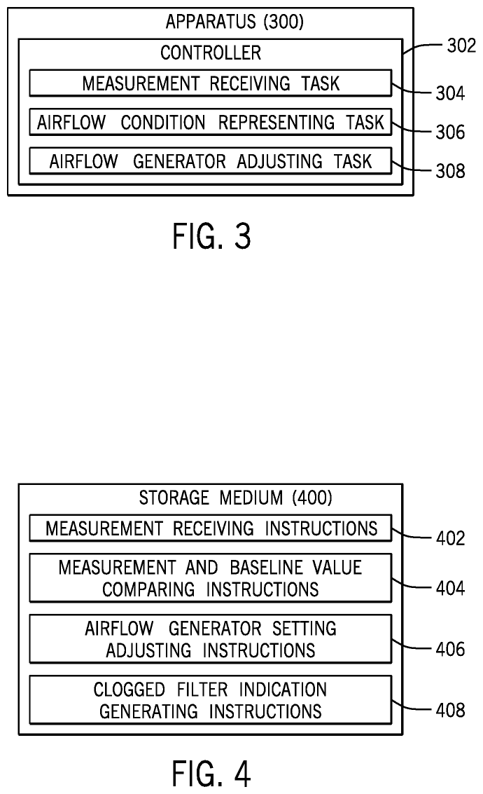

FIG. 3 is a block diagram of an apparatus 300 that includes a controller 302 to perform various tasks. The tasks of the controller 302 include a measurement receiving task 304 to receive a measurement from a sensor in an enclosure that includes an imaging device. The tasks further include an airflow condition representing task 306 that uses the measurement and a baseline value to represent a condition of an airflow flowing through a filter that removes particulates from an incoming airflow into the enclosure. The tasks further include an airflow generator adjusting task 308 to, based on the measurement and the baseline value, selectively adjust a setting of an airflow generator that causes the incoming airflow through an inlet into the enclosure, or indicate that the filter is to be replaced.

FIG. 4 is a block diagram of a non-transitory machine-readable or computer-readable storage medium 400 storing machine-readable instructions that upon execution cause a controller to perform various tasks. The machine-readable instructions include measurement receiving instructions 402 to receive a measurement from a sensor in an enclosure that includes an imaging device. The machine-readable instructions further include measurement and baseline value comparing instructions 404 to compare the measurement to a baseline value to estimate a condition of a filter that removes particulates from an incoming airflow into the enclosure.

The machine-readable instructions further include airflow generator setting adjusting instructions 406 and clogged filter indication generating instructions 408 that are selectively executed based on a difference of the measurement and the bassline value exceeding a threshold. The airflow generator setting adjusting instructions 406 adjust a setting of an airflow generator that causes airflow into the enclosure through the filter in response to determining that the airflow generator can be adjusted to compensate for the condition of the filter. The clogged filter indication generating instructions 408 generate an indication of a clogged filter in response to determining that the airflow generator cannot be adjusted to compensate for the condition of the filter.

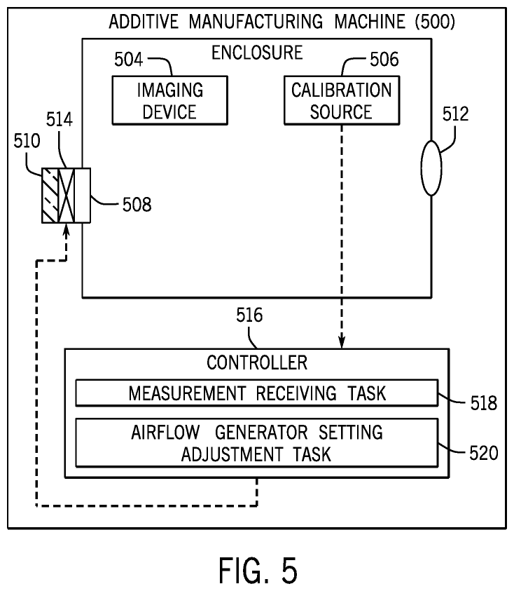

FIG. 5 is a block diagram of an additive manufacturing machine 500 that includes an enclosure 502 containing an imaging device 504 and a calibration source 506 for the imaging device 504. The enclosure 502 includes an airflow inlet 508, a filter 510 to remove particulates from an incoming airflow through the airflow inlet 508, and an outlet aperture 512.

An airflow generator 514 causes the incoming airflow through the airflow inlet 508. The additive manufacturing machine 500 further includes a controller 516 to perform various tasks, including a measurement receiving task 518 to receive a measurement from the calibration source 506, and an airflow generator setting adjustment task 520 to, based on the measurement from the calibration source 506, adjust a setting of the airflow generator 514.

The storage medium 400 of FIG. 4 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (e.g., a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An apparatus comprising:
a controller to:
receive a measurement from a sensor in an enclosure;
use the measurement and a baseline value to represent a condition of an airflow flowing through a filter that removes particulates from an incoming airflow into the enclosure; and
based on the measurement and the baseline value, selectively:
adjust a setting of an airflow generator that causes the incoming airflow through an inlet into the enclosure, or
indicate that the filter is to be replaced.

2. The apparatus of claim 1, wherein the baseline value is derived for a clean filter, and wherein a difference between the measurement and the baseline value represents a clogged condition of the filter.

3. The apparatus of claim 1, wherein the controller is to adjust the setting of the airflow generator responsive to a determination that the condition of the airflow can be compensated by adjusting the incoming airflow.

4. The apparatus of claim 3, wherein the enclosure includes an imaging device, and wherein the adjusting of the setting of the airflow generator is to provide a condition of the enclosure that reduces ingress of contaminants into the enclosure, maintains the imaging device in an isothermal condition, and reduces a rate of air outflow through an outlet aperture of the enclosure to reduce disturbance of a processing environment.

5. The apparatus of claim 1, wherein the controller is to indicate that the filter is to be replaced responsive to a determination that the condition of the airflow cannot be compensated for by adjusting the setting of the airflow generator.

6. The apparatus of claim 1, wherein the controller is to detect clogging of the filter in response to determining that the measurement differs from the baseline value by greater than a specified amount.

7. The apparatus of claim 1, wherein the measurement corresponds to an amount of an electrical current provided to a heater that heats a calibration plate used to calibrate an imaging device in the enclosure.

8. The apparatus of claim 7, wherein the amount of the electrical current provided to the heater that heats the calibration plate correlates to a flow parameter of an air outflow from an outlet aperture of the enclosure.

9. The apparatus of claim 8, wherein the amount of the electrical current provided to the heater that heats the calibration plate is the amount of the electrical current for maintaining the calibration plate at a target temperature or within a target range of temperatures.

10. The apparatus of claim 7, wherein a calibration source comprising the heater and the calibration plate is used as part of an anemometer to estimate the condition of the airflow.

11. A non-transitory machine-readable storage medium comprising instructions that upon execution cause a controller to:
receive a measurement from a sensor in an enclosure;
compare the measurement to a baseline value to estimate a condition of a filter that removes particulates from an incoming airflow into the enclosure; and
based on a difference of the measurement and the bassline value exceeding a threshold:
in response to determining that the airflow generator can be adjusted to compensate for the condition of the filter, adjust a setting of an airflow generator that causes airflow into the enclosure through the filter, and
in response to determining that the airflow generator cannot be adjusted to compensate for the condition of the filter, generate an indication of a clogged filter.

12. The non-transitory machine-readable storage medium of claim 11, wherein the airflow generator cannot be adjusted to compensate for the condition of the filter if a setting of the airflow generator exceeds a specified value.

13. The non-transitory machine-readable storage medium of claim 11, wherein the measurement represents an amount of an electrical current provided to a heater that heats a calibration plate used to calibrate an imaging device in the enclosure.

14. An additive manufacturing machine comprising:
an enclosure containing an imaging device and a calibration source for the imaging device, the enclosure comprising an airflow inlet, a filter to remove particulates from an incoming airflow through the airflow inlet, and an outlet aperture;
an airflow generator to cause the incoming airflow through the airflow inlet; and
a controller to:
receive a measurement from the calibration source, and
based on the measurement from the calibration source, adjust a setting of the airflow generator.

15. The additive manufacturing machine of claim 14, wherein the adjusting of the setting of the airflow generator is based on correlating different measurements from the calibration source to respective flow conditions of the enclosure.
